(19) United States
(12) Patent Application Publication
(10) Pub. No.: US 2020/0074509 A1
(43) Pub. Date: Mar. 5, 2020

(54) BUSINESS DATA PROMOTION METHOD, DEVICE, TERMINAL AND COMPUTER-READABLE STORAGE MEDIUM

(71) Applicant: Baidu Online Network Technology (Beijing) Co., Ltd., Beijing (CN)

(72) Inventor: Chen SHANG, Beijing (CN)

(21) Appl. No.: 16/555,977

(22) Filed: Aug. 29, 2019

(30) Foreign Application Priority Data
Aug. 31, 2018 (CN) 201811011771.5

(51) Int. Cl. G06Q 30/02

(52) U.S. Cl. CPC G06Q 30/0271; G06Q 30/0255

(57) ABSTRACT

Embodiments of a business data promotion method, device, terminal and a computer-readable storage medium are provided. The method can include: acquiring historical behavior data of a user; acquiring a data item of the user's interest, according to the historical behavior data of the user; and for each business scenario, generating a personalized promotion data item of the user, based on the data item of the user's interest and a preset promotion data item. In an embodiment of the present application, a relatively reasonable guidance scheme is provided with respect to the promotion demands of different users, so as to improve the promotion effect to the user in different business scenarios and the effect of increasing the traffic.

### CROSS-REFERENCE TO RELATED APPLICATION

This application claims priority to Chinese Patent Application No. 201811011771.5, filed on Aug. 31, 2018, and entitled “Business Data Promotion Method, Device, Terminal and Computer-Readable Storage Medium”, which is hereby incorporated by reference in its entirety.

### TECHNICAL FIELD

The present application relates to a field of commercial promotion technology, and in particular, to a business data promotion method, device, terminal and a computer-readable storage medium.

### BACKGROUND

There are two problems, respectively at a product level and a technical level, in the existing commercial promotion. At the product level, different promotion products are typically used in different scenarios. Although there are many such products, there is a certain coincidence in targets among them. Further, the product operation is difficult to be executed and commercial promotion guidance is not provided to customers, thereby resulting in a less acceptable degree of the customers. At the technical level, after a product manager determines data to be disclosed to the customers in each preset scenario through product design, the product development is performed to the data to be disclosed. However, when additional business functions need to be developed in a newly added scenario, corresponding codes are required to be redeveloped and launched after a change in demands It can be seen that, currently, there is no such a system which can provide a relatively reasonable guidance scheme for different customer promotion demands in the field of commercial promotion.

The above-mentioned information disclosed in the background art is only used to enhance an understanding of the background of the present disclosure, and may therefore contain information that does not form the prior art known to those skilled in the art.

### SUMMARY

A business data promotion method, device, terminal and a computer-readable storage medium are provided according to embodiments of the present application, so as to at least solve the above technical problems in the existing technology.

According to a first aspect, a business data promotion method includes:

acquiring historical behavior data of a user;

acquiring a data item of the user's interest, according to the historical behavior data of the user; and

for each business scenario, generating a personalized promotion data item of the user, based on the data item of the user's interest and a preset promotion data item.

In conjunction with the first aspect, in a first implementation of the first aspect of the present application, the method further includes:

updating the historical behavior data of the user;

updating the data item of the user's interest, according to the updated historical behavior data of the user; and

for each business scenario, generating a new personalized promotion data item of the user, based on the updated data item of the user's interest and the personalized promotion data item.

In conjunction with the first implementation of the first aspect, in a second implementation of the first aspect of the present application, the method further includes:

acquiring to-be-promoted data from at least one data source, according to a business scenario entered by the user and the personalized promotion data item corresponding to the entered business scenario; and

organizing the to-be-promoted data according to the personalized promotion data item to acquire an organized result, and transmitting the organized result to a display end for presentation.

In conjunction with the second implementation of the first aspect, in a third implementation of the first aspect of the present application, wherein the acquiring to-be-promoted data from at least one data source, according to a business scenario entered by the user and the personalized promotion data item corresponding to the entered business scenario, includes:

updating the historical behavior data of the user in response to an access request to the entered business scenario initiated by the user;

updating the data item of the user's interest according to the updated historical behavior data of the user; and

for the entered business scenario, generating a latest personalized promotion data item, based on the updated data item of the user's interest and the personalized promotion data item.

According to a second aspect, a business data promotion device is provided in the embodiment of the present application, including:

a history behavior data module configured to acquire history behavior data of a user;

an interest data item module configured to acquire acquiring a data item of the user's interest, according to the historical behavior data of the user; and

a personalized promotion data item module configured to, for each business scenario, generate a personalized promotion data item of the user, based on the data item of the user's interest and a preset promotion data item.

In one possible design, the device further includes:

a first updating module configured to update the historical behavior data of the user;

a second updating module configured to update data item of the user's interest, according to the updated historical behavior data of the user; and

a third updating module configured to, for each business scenario, generate a new personalized promotion data item of the user, based on the updated data item of the user's interest and the personalized promotion data item.

In one possible design, the device further includes:

an acquiring module configured to acquire to-be-promoted data from at least one data source, according to a business scenario entered by the user and the personalized promotion data item corresponding to the entered business scenario; and

a data organizing module configured to organize the to-be-promoted data according to the personalized promotion data item to acquire an organized result, and transmitting the organized result to a display end for presentation.

In one possible design, the acquiring module includes:

a first updating sub-module configured to update the historical behavior data of the user in response to an access request to the entered business scenario initiated by the user;

a second updating sub-module configured to update the data item of the user's interest according to the updated historical behavior data of the user; and

a third updating sub-module configured to, for the entered business scenario, generate a latest personalized promotion data item, based on the updated data item of the user's interest and the personalized promotion data item.

In a third aspect, a business data promotion terminal is provided according to an embodiment of the present application, the terminal includes: one or more processors; and a memory configured for storing one or more programs, wherein the one or more programs are executed by the one or more processors to enable the one or more processors to implement the method according to the first aspect.

The functions of the device may be implemented by hardware, or by hardware executing corresponding software. The hardware or software includes one or more modules corresponding to the above functions.

In a possible design, the memory of the business data promotion terminal is configured to store a program for supporting the above business data promotion method executed by the business data promotion terminal, and the processor is configured to execute the program stored in the memory. The business data promotion terminal further includes a communication interface configured for communication between the business data promotion terminal and another apparatus or communication network.

In a fourth aspect, a computer-readable storage medium is provided for storing computer software instructions used by the business data promotion terminal, the computer software instructions include programs involved in execution of the above business data promotion method.

One of the above technical solutions has the following advantages or beneficial effects: in an embodiment of the present application, according to the historical behavior data of the user, it is possible to obtain the data item of the user's interest by analyzing. A relatively reasonable guidance scheme is provided with respect to the promotion demands of different users, so as to improve the promotion effect to the user in different business scenarios and the effect of increasing the traffic.

The above summary is for the purpose of the specification only and is not intended to be limiting in any way. In addition to the illustrative aspects, embodiments, and features described above, further aspects, embodiments, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some embodiments disclosed in accordance with the present application and are not to be considered as limiting the scope of the present application.

FIG. 1 is a flowchart of a business data promotion method according to an embodiment of the present application.

FIG. 2 is a flowchart of a business data promotion method according to an embodiment of the present application.

FIG. 3 is a flowchart of a business data promotion method according to another embodiment of the present application.

FIG. 4 is a specific flowchart of step S700 of the embodiment of the present application.

FIG. 5 is a schematic diagram of a business scenario display interface according to an embodiment of the present application;

FIG. 6 is a schematic diagram of a business scenario display interface according to an embodiment of the present application.

FIG. 7 is a schematic diagram of a business scenario display interface according to an embodiment of the present application;

FIG. 8 is a flowchart of a business data promotion method according to an application example of an embodiment of the present application.

FIG. 9 is a structural block diagram of a business data promotion device according to an embodiment of the present application.

FIG. 10 is a structural block diagram of a business data promotion device according to an embodiment of the present application.

FIG. 11 is a structural block diagram of a business data promotion device according to another embodiment of the present application.

FIG. 12 is a structural block diagram of an acquiring module according to an embodiment of the present application.

FIG. 13 is a schematic structural diagram of a business data promotion terminal according to an embodiment of the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

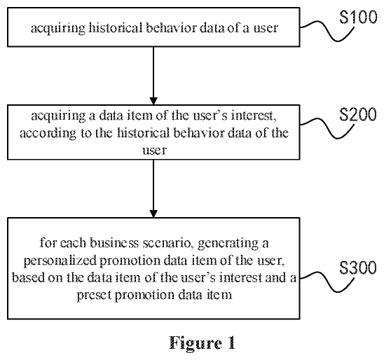

A business data promotion method is provided in an embodiment of the present application, as shown in FIG. 1. The method includes the steps S100 to S300.

In S100, historical behavior data of a user is acquired. The historical behavior data may include behavior data that represents user viewing and/or operating a corresponding data item in a respective business scenario each time. The historical behavior data is stored in a database. The historical behavior data of the user is acquired from the database as needed.

In one embodiment, the historical behavior data may be associated with the user by an ID (Identity) of this user. For example, in the database, an index is established by using user IDs, and historical behavior data of a user can be found according to the ID of this user.

In S200, a data item of the user's interest is acquired according to the historical behavior data of the user. Since there are many types and a large number of data in the historical behavior data of the user, it is possible to determine user demands, such as the data item of the user's interest, more accurately by analyzing and filtering the historical behavior data.

It should be noted that the method for analyzing and filtering can be selected adaptively as required. The specific method for analyzing and filtering are not specifically limited herein, and it is possible to acquire the data item to which the user paid relative more attention or is of the user's more interest from historical behavioral data by any method in the prior art.

In S300, for each business scenario, a personalized promotion data item of the user is generated, based on the data item of the user's interest and a preset promotion data item. Since the preset promotion data items in each business scenario are directed to all users, demands of different users for the same business scenario cannot be met. By associating attention data item of each user's interest with the preset promotion data items in the business scenario, better-directed personalized promotion data items in different scenarios can be provided to the users. Therefore, business data of a user's more interest may be acquired and intelligent business data promotion for different users may be achieved.

It should be noted that, since the historical behavior data is different for different user IDs, the acquired data item of the user's interest for each user is also different. Therefore, once different users enter the same business scenario, the promotion data and promotion data items displayed in the same business scenario are also dynamically changed.

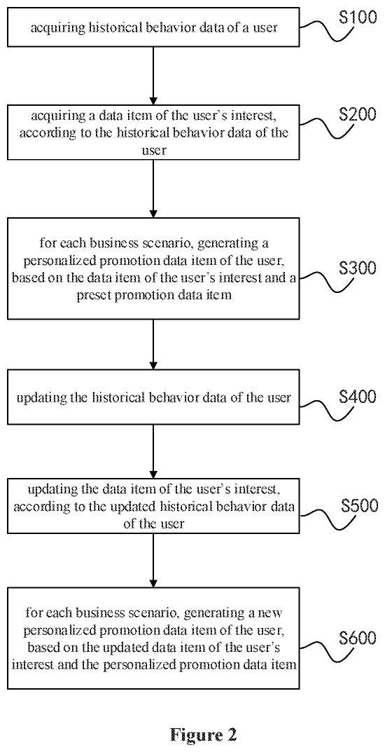

In one embodiment, as shown in FIG. 2, the method further includes steps S400 to S600.

In S400, the historical behavior data of the user is updated. The attention from the user paid to the promotion data is also varying in real time according to product characteristics and changes in promotion usage. For example, customers pay more attention to traffic during the industry peak season and to consumption during the low season, and a key customer pays more attention to bidding from a competitor, and the like. Thus, the latest historical behavior data of the user can be acquired in real time or periodically.

In S500, the data item of the user's interest is updated according to the updated historical behavior data of the user. According to a large number of data samples in the latest historical behavior data as acquired, the data item of the user's interest to which the user paid the most attention currently is acquired by continuously iterating through AI (Artificial Intelligence) strategies.

In one embodiment, a model may be established for each user. The data item of the user's interest in the historical behavior data may be acquired by calculating with the model. After the historical behavior data is updated, part of the new historical behavior data is collected as a training sample. Then the model may be optimized by continuous iterations for the data. In this way, the latest data item of each user's interest may be calculated by the model.

In S600, for each business scenario, a new personalized promotion data item of the user is generated, based on the updated data item of the user's interest and the personalized promotion data item. For example, in the case of a customer promotion activity (during a holiday or a shop celebration, etc.), an industry peak season (a burst increase in search traffic), and a traffic remediation (a significant fall in search traffic), there is a substantial demand for a large amount of additional traffic. Therefore, the latest personalized promotion data items in different scenarios needs to be acquired by quickly iterating, so as to meet user demands

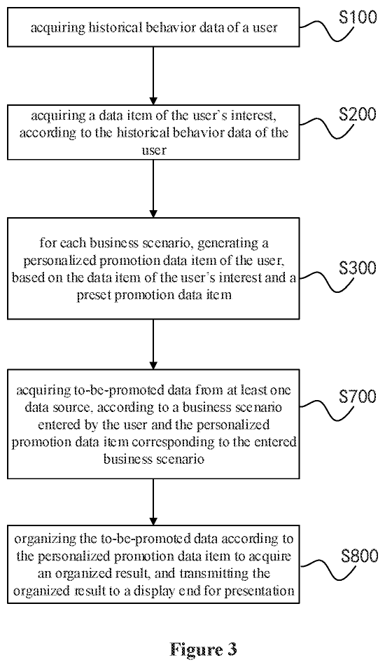

In one embodiment, as shown in FIG. 3, the method further includes steps S700 to S800.

In S700, to-be-promoted data from at least one data source is acquired, according to a business scenario entered by the user and the personalized promotion data item corresponding to the entered business scenario.

In S800, the to-be-promoted data is organized according to the personalized promotion data item to acquire an organized result, and the organized result is transmitted to a display end for presentation. After rendering the organized result, the result is displayed visually by the display end to the user for viewing or operation in the form of a visual interface.

In one embodiment, as shown in FIG. 3, acquiring to-be-promoted data from at least one data source, according to a business scenario entered by the user and the personalized promotion data item corresponding to the entered business scenario includes the steps S710 to S730.

In S710, the historical behavior data of the user is updated in response to an access request to the business scenario initiated by the user.

In S720, the data item of the user's interest is updated according to the updated historical behavior data of the user.

In S730, for the entered business scenario, a latest personalized promotion data item is generated, based on the updated data item of the user's interest and the personalized promotion data item. Thus, the personalized promotion data item for a business scenario can be updated in real time when a user enters the business scenario, so as to achieve a dynamic data disclosure mechanism.

In one embodiment, acquiring the data item of the user's interest according to the historical behavior data of the user includes:

acquiring a predefined data filtering rule; wherein the data filtering rule may be selected as required, for example, data items in historical behavior data may be organized based on a function. Functions may include presentation, click, consumption, CTR (Click-Through-Rate), average click price, ranking, topology, and the like.

according to the data filtering rule, acquiring a data item of the user's interest from the historical behavior data of the user.

In one embodiment, by associating the data item of the user's interest with the business scenario in an online or offline manner, the data item of the user's interest may be matched with a preset promotion data item a business scenario.

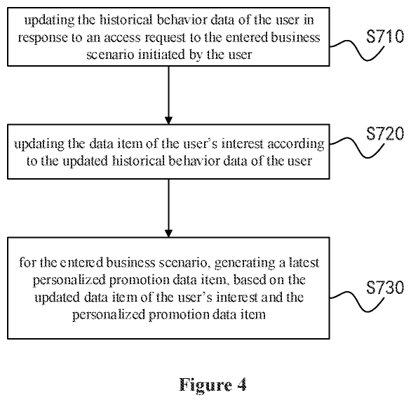

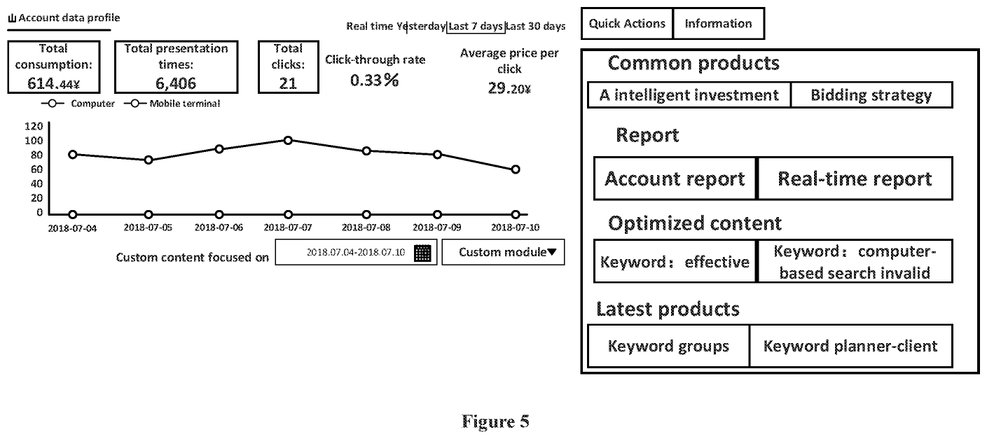

In one embodiment, the historical behavior data of the user may be recorded and acquired through tracking. As shown in FIGS. 5-7, a tracking point is set in each of the promotion data items (preset promotion data items and/or personalized promotion data items) in the presentation interface of a business scenario. If the user clicks a promotion data item, a corresponding operation behavior of the user is recorded.

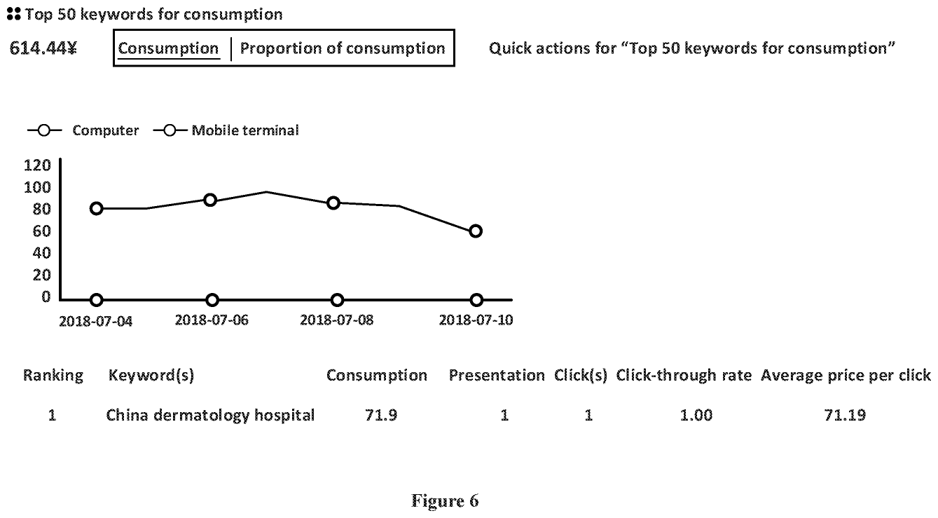

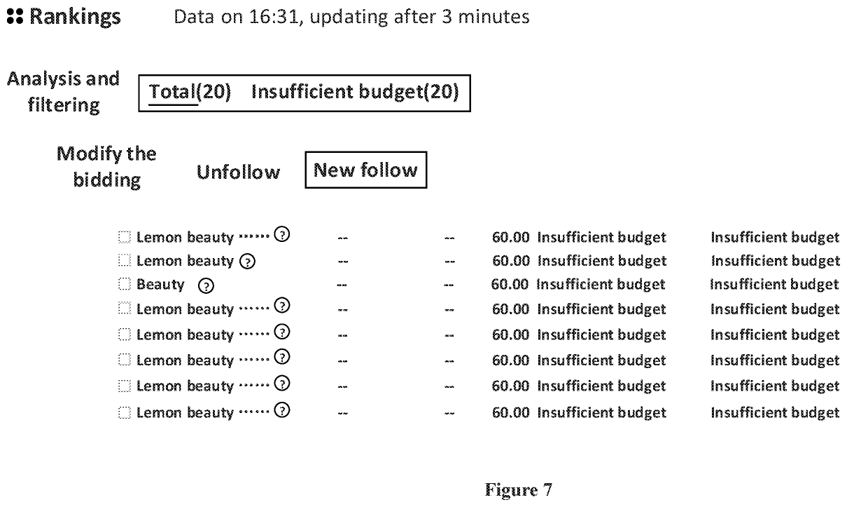

For example, as shown in FIG. 5, a tracking point is set in each of the promotion data items, such as “total consumption”, “total presentation”, “total clicks”, “common products”, “report”, “optimized content” and “latest product”. In FIG. 6, a tracking point is set in each of the promotion data items, such as “consumption”, “proportion of consumption”. In FIG. 7, a tracking point is set in each of the promotion data items, such as “total”, “insufficient budget” and “new follow”.

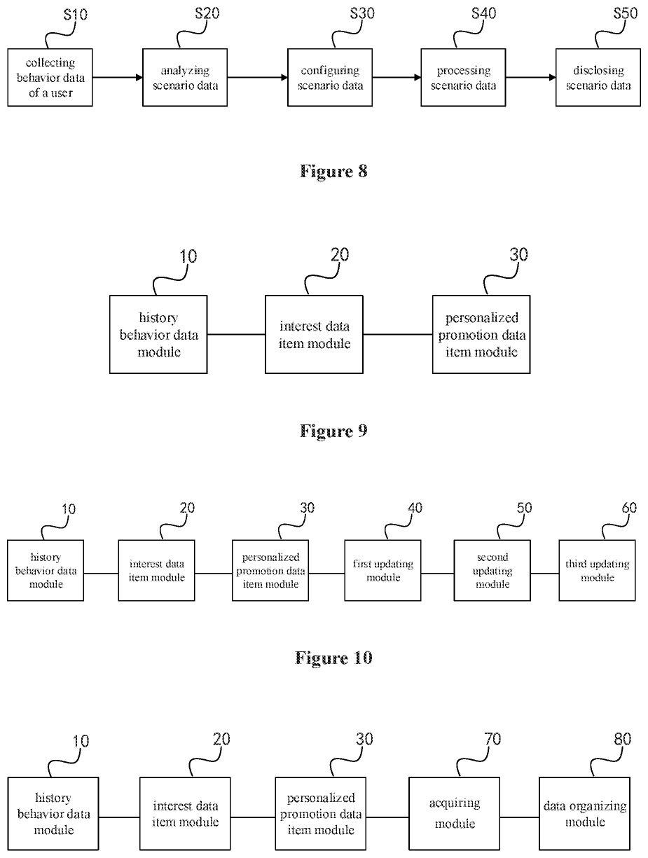

In one application example, as shown in FIG. 8, the business data promotion method may include the following steps of S10 to S50.

In S10, behavior data of a user is collected. At a promotion management end, the viewing or operating behavior of the user to promotion data and the promotion data items in each business scenario have been recorded each time. The data may be recorded in a website and transmitted to a bigdata database via minos.

In S20, scenario data is analyzed. By extracting the behavior data of the user, the promotion data is organized in function according to a dimension of the user ID. The function may include presentation, click, consumption, CTR, average click price, ranking, topology, and the like. The promotion data and the promotion data items to which the user paid more attention can be acquired from a large amount of monitoring data, an analysis result thereof is synchronized among the business scenarios in an off-line manner.

In S30, scenario data is configured. According to a strategy configuration of the business scenario (for preset promotion data items) combined with a configuration of the data item of the user's interest as acquired in real time or periodically, data schema of the user's interest (a set of objects) on different business scenarios may be acquired by merging. The data schema is a personalized promotion data item.

In S40, scenario data is processed. When the user enters the scenario, a back end (server end) is requested by a front end (display end) to acquire a defined schema for a user ID scenario, and data is acquired by the back end according to a data item in the schema, for example, through an API (Application Programming Interface). A result from each data source is then acquired by merging data in a memory.

In S50, scenario data is disclosed. The defined schema finally acquired is filled with returned data and is returned to the front end for rendering. Then, it is displayed by the front end for viewing or operating by the user.

A business data promotion device is provided in an embodiment of the present application provides, as shown in FIG. 9, which includes following modules 10 to 30.

A history behavior data module 10 is configured to acquire history behavior data of a user.

An interest data item module 20 is configured to acquire a data item of the user's interest, according to the historical behavior data of the user.

A personalized promotion data item module 30 is configured to, for each business scenario, generate a personalized promotion data item of the user, based on the data item of the user's interest and a preset promotion data item.

In one embodiment, as shown in FIG. 10, the business data promotion device further includes modules 40 to 60.

A first updating module 40 is configured to update the historical behavior data of the user.

A second updating module 50 is configured to update the data item of the user's interest, according to the updated historical behavior data of the user.

A third updating module 60 is configured to, for each business scenario, generate a new personalized promotion data item of the user, based on the updated data item of the user's interest and the personalized promotion data item.

In one embodiment, as shown in FIG. 11, the business data promotion device further includes modules:

an acquiring module 70 configured to acquire to-be-promoted data from at least one data source, according to a business scenario entered by the user and the personalized promotion data item corresponding to the entered business scenario; and

a data organizing module 80 configured to organize the to-be-promoted data according to the personalized promotion data item to acquire an organized result, and transmitting the organized result to a display end for presentation.

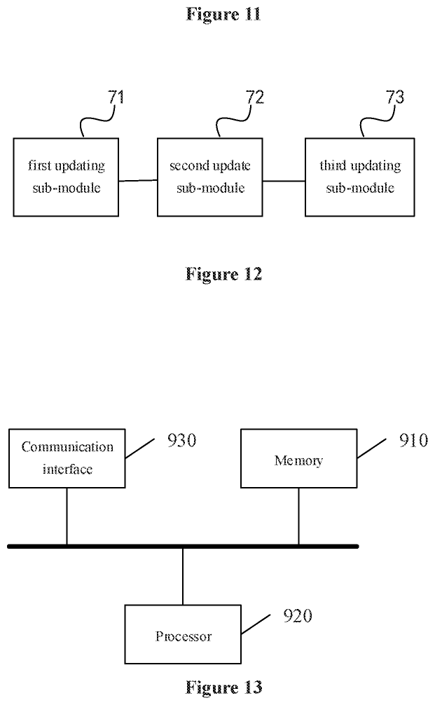

In one embodiment, as shown in FIG. 12, the acquiring module 70 includes:

a first updating sub-module 71 configured to update the historical behavior data of the user in response to an access request to the entered business scenario initiated by the user.

a second updating sub-module 72 configured to update the data item of the user's interest according to the updated historical behavior data of the user; and

a third updating sub-module 73 configured to, for the entered business scenario, generate a latest personalized promotion data item, based on the updated data item of the user's interest and the personalized promotion data item.

As shown in FIG. 13, a terminal for business data promotion is provided in an embodiment of the present application, including a memory 910 and a processor 920. The memory 910 stores a computer program executable on the processor 920. When the processor 920 executes the computer program, the business data promotion method in the foregoing embodiment is implemented. The number of the memory 910 and the processor 920 may be one or more.

The terminal for business data promotion further includes:

a communication interface 930 configured to communicate with an external device and exchange data.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 may be connected to each other through a bus and communicate with one another. The bus may be an Industry Standard Architecture (ISA) bus, a Peripheral Component (PCI) bus, an Extended Industry Standard Component (EISA) bus, or the like. The bus may be divided into an address bus, a data bus, a control bus, and the like. For ease of illustration, only one bold line is shown in FIG. 8, but it does not mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

According to an embodiment of the present application, a computer-readable storage medium is provided for storing computer software instructions, which include programs involved in execution of the above business data promotion method.

The embodiments of the present disclosure have the following advantages: 1. According to the user's historical behavior data, it is possible to analyze user's attention data item. A relatively reasonable guidance scheme is provided with respect to the promotion of different users, so as to improve the promotion of the user in different business scenarios and the topological effect. Therefore, the user's promotion may be quickly and efficiently completed to improve the promotion effect and enhance the user's experience. 2. The user's attention data item may be acquireed by analyzing the user's historical behavior data. And the scenario dynamic data disclosure mechanism may be established in different business scenarios according to the attention data item. 3. By collecting a large number of data samples and, the promotion data item, which the customer are most concerned, can be iterated by the AI strategy to accurately guide the customer to use the product and improve the promotion effect. 4. After defining a scenario data item and identifying and configuring a data source, a data request and data aggregation can be dynamically performed to reduce additional requirement development brought by different scenarios.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically acquire the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A business data promotion method, comprising:
acquiring historical behavior data of a user;
acquiring a data item of the user's interest, according to the historical behavior data of the user; and
for each business scenario, generating a personalized promotion data item of the user, based on the data item of the user's interest and a preset promotion data item.

2. The business data promotion method according to claim 1, further comprising:
updating the historical behavior data of the user;
updating the data item of the user's interest, according to the updated historical behavior data of the user; and
for each business scenario, generating a new personalized promotion data item of the user, based on the updated data item of the user's interest and the personalized promotion data item.

3. The business data promotion method according to claim 1, further comprising:
acquiring to-be-promoted data from at least one data source, according to a business scenario entered by the user and the personalized promotion data item corresponding to the entered business scenario; and
organizing the to-be-promoted data according to the personalized promotion data item to acquire an organized result, and transmitting the organized result to a display end for presentation.

4. The business data promotion method according to claim 3, wherein the acquiring to-be-promoted data from at least one data source, according to a business scenario entered by the user and the personalized promotion data item corresponding to the entered business scenario, comprises:
updating the historical behavior data of the user in response to an access request to the entered business scenario initiated by the user;
updating the data item of the user's interest according to the updated historical behavior data of the user; and
for the entered business scenario, generating a latest personalized promotion data item, based on the updated data item of the user's interest and the personalized promotion data item.

5. A business data promotion device, comprising:
a history behavior data module configured to acquire history behavior data of a user;
an interest data item module configured to acquire a data item of the user's interest, according to the historical behavior data of the user; and
a personalized promotion data item module configured to, for each business scenario, generate a personalized promotion data item of the user, based on the data item of the user's interest and a preset promotion data item.

6. The business data promotion device according to claim 5, further comprising:
a first updating module configured to update the historical behavior data of the user;
a second updating module configured to update the data item of the user's interest, according to the updated historical behavior data of the user; and
a third updating module configured to, for each business scenario, generate a new personalized promotion data item of the user, based on the updated data item of the user's interest and the personalized promotion data item.

7. The business data promotion device according to claim 5, further comprising:
an acquiring module configured to acquire to-be-promoted data from at least one data source, according to a business scenario entered by the user and the personalized promotion data item corresponding to the entered business scenario; and
a data organizing module configured to organize the to-be-promoted data according to the personalized promotion data item to acquire an organized result, and transmitting the organized result to a display end for presentation.

8. The business data promotion device according to claim 7, wherein the acquiring module comprises:
a first updating sub-module configured to update the historical behavior data of the user in response to an access request to the entered business scenario initiated by the user;
a second updating sub-module configured to update the data item of the user's interest according to the updated historical behavior data of the user; and
a third updating sub-module configured to, for the entered business scenario, generate a latest personalized promotion data item, based on the updated data item of the user's interest and the personalized promotion data item.

9. A business data promotion terminal, comprising:
one or more processors; and
a memory configured for storing one or more programs, wherein
the one or more programs are executed by the one or more processors to enable the one or more processors to implement the method of claim 1.

10. A non-transitory computer-readable storage medium, in which a computer program is stored, wherein the computer program, when executed by a processor, causes the processor to implement the method of claim 1.
